(19) United States
(12) Patent Application Publication
(10) Pub. No.: US 2020/0062576 A1
(43) Pub. Date: Feb. 27, 2020

(54) DEVICE FOR PREVENTING LEAKAGE OF GAS WITHIN CONTAINER

(71) Applicant: Seong Gyu CHOI, Chilgok-gun (KR)

(72) Inventor: Seong Gyu CHOI, Chilgok-gun (KR)

(21) Appl. No.: 16/611,816

(22) PCT Filed: May 8, 2018
(86) PCT No.: PCT/KR2018/005271

§ 371 Date: Nov. 7, 2019

(30) Foreign Application Priority Data
May 8, 2017 (KR) 10-2017-0057164

(51) Int. Cl. B67D 3/00

(52) U.S. Cl. CPC B67D 3/0061; B67D 3/0032

(57) ABSTRACT

The present invention relates to a device for preventing leakage of gas within a container, and more particularly, to a device for preventing leakage of gas within a container, wherein the device prevents gas contained in a beverage from leaking to the outside. To this end, the device for preventing leakage of gas within a container according to the present invention includes: a fixing tool having a certain thickness and divided into two or more parts; a first fastening member that has a hollow pipe shape and is divided into two or more parts in the longitudinal direction, the first fastening member having a mounting part, which is formed on the inside of an upper end and into which a portion of the fixing tool is inserted, and having threads, which are formed on the inside and outside of the lower end; a coupling member coupled to the threads formed on the outside of the lower end of the first fastening member so that the first fastening members divided into two or more parts are fixed while coupled to each other; a second fastening member having a hollow pipe shape and having a sealing mounting part, which is formed on the upper end and into which a portion of sealing is inserted, the second fastening member being inserted into the first fastening member by the threads formed on the outside thereof; a perforation member which is inserted into the second fastening member, has a hollow pipe shape, has at least one through-hole formed in an upper end that is cone-shaped, and has a lower end that is open; and a pressing member into which the lower end of the perforation member is inserted.

### TECHNICAL FIELD

The present invention relates to a device for preventing leakage of gas within a container, and more particularly, to a device for preventing leakage of gas within a container, wherein the device prevents gas contained in a beverage from leaking to the outside.

### BACKGROUND ART

In general, in order to drink beer, soju and soda contained in an airtight storage container, it is necessary to open a container cap. When opening the container cap, the flavor and fragrance are instantly released from an inside of the storage container. In addition, during drinking, a user generally keeps the storage container in an open state without closing the storage container by the container cap.

As the time lapses in the open state of the storage container, the flavor and fragrance (carbonate) of the beverage may be degraded while causing rapid acidification.

Since the flavor and fragrance of the beverage are degraded with rapid acidification, there is a problem in terms of sanitary.

Therefore, the beverage in the storage container needs to be consumed within a short period of time, and, when the storage container is opened for a long period of time, the remaining beverage has to be discarded.

In particular, when drinking the beverage intermittently in an unsanitary space, not only the flavor and fragrance (carbonate) in the storage container may be released whenever the storage container is opened, but also the quality of the flavor and fragrance may be degraded and the beverage may be contaminated as time lapses because unsanitary air is filled in an empty space of the storage container.

In order to solve the above problems, several related arts are proposed such as Korean Registered Utility Model Publication Nos. 20-0292087 (beer can), 20-0280803 (opening device for beer can), etc.

The above-mentioned related arts allow a user to drink the beverage in an open state of the storage container while allowing air to flow into the storage container by opening an air opening and closing device.

That is, according to the related arts, an air inlet, which is manually operated, is basically provided at an upper portion and an opening of a lower portion through which contents are discharged is clogged by a cork. In this state, when it is necessary to obtain the contents, the air inlet is opened such that air may flow into the air inlet and the cork provided at the lower portion is opened.

### DETAILED DESCRIPTION OF THE INVENTION

### Technical Problem

An object of the present invention is to provide a method of easily puncturing a cap of a container.

Another object of the present invention is to provide a method for preventing air contained in a beverage from leaking to the outside.

Still another object of the present invention is to provide a method of allowing a user to easily drink a beverage if necessary.

### Technical Solution

To this end, a device for preventing leakage of gas within a container according to the present invention includes: a fixing tool having a certain thickness and divided into two or more parts; a first fastening member that has a hollow pipe shape and is divided into two or more parts in the longitudinal direction, the first fastening member having a mounting part, which is formed on the inside of an upper end and into which a portion of the fixing tool is inserted, and having threads, which are formed on the inside and outside of the lower end; a coupling member coupled to the threads formed on the outside of the lower end of the first fastening member so that the first fastening members divided into two or more parts are fixed while coupled to each other; a second fastening member having a hollow pipe shape and having a sealing mounting part, which is formed on the upper end and into which a portion of sealing is inserted, the second fastening member being inserted into the first fastening member by the threads formed on the outside thereof; a perforation member which is inserted into the second fastening member, has a hollow pipe shape, has at least one through-hole formed in an upper end that is cone-shaped, and has a lower end that is open; and a pressing member into which the lower end of the perforation member is inserted.

### Advantageous Effects of the Invention

A device for preventing leakage of gas within a container according to the present invention can easily perforate a cap of a beverage container by using a conical perforating member, and can prevent air contained in a beverage from leaking to the outside by allowing a second fastening member to make close contact with a cap of the beverage container.

In addition, the present invention can allow a user to easily drink a beverage contained in a beverage container if necessary by using a stop valve.

### DESCRIPTION OF THE DRAWINGS

FIG. 1 is a view showing a configuration of a device for preventing leakage of gas within a container according to one embodiment of the present invention.

FIG. 2 is a view showing a state in which an end of a second fastening member is in close contact with a cap according to one embodiment of the present invention.

FIG. 3 is a view showing the operation of a device for preventing leakage of gas within a container according to one embodiment of the present invention.

### BEST MODE

As a best mode of the present invention, there is provided a device for preventing leakage of gas within a container, the device including: a fixing member including at least two parts combined with each other and corresponding to an upper portion of a beverage container; a first fastening member including at least two parts combined with each other to form a hollow pipe shape, provided at an upper inner portion thereof with a mounting part configured to install the fixing member, and provided at outer and inner portions of a lower end thereof with a fastening part; a coupling member configured to fix the first fastening member in a combined state; a second fastening member having a hollow pipe shape, provided at an upper end thereof with a seal ring mounting part into which a seal ring is partially inserted, and inserted into the first fastening member by a screw thread formed at an outer side thereof; a perforating member inserted into the second fastening member, having a hollow pipe shape, formed at a conical upper end thereof with a through hole, and having a lower end which is opened; and a pressing member into which a lower end of the perforating member is inserted.

### MODE FOR INVENTION

The foregoing and further aspects of the present invention will become more apparent through the exemplary embodiments described with reference to the accompanying drawings. Hereinafter, embodiments of the present invention will be described in detail to enable those skilled in the art to easily understand and implement the embodiments of the present invention.

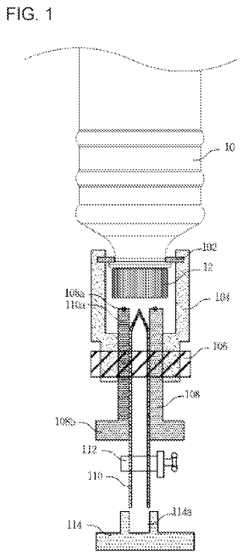

FIG. 1 is a view showing a configuration of a device for preventing leakage of gas within a container according to one embodiment of the present invention. Hereinafter, the configuration of the device for preventing leakage of gas within a container according to one embodiment of the present invention will be described in detail with reference to FIG. 1.

According to FIG. 1, the device for preventing leakage of gas within a container includes a fixing member having at least two parts combined with each other in a circular shape, a first fastening member, a coupling member, a second fastening member, a perforating member, a pressing member and a stop valve. In addition to the above-described configuration, other components may be included in the device for preventing leakage of gas within a container proposed by the present invention.

The fixing member 102 described above may include two semicircular parts having a predetermined thickness. In the present invention, the fixing member 102 having the semicircular shape may be prepared by cutting a circular ring into halves. Various fixing members having various shapes other than the semicircular shape may be included in the fixing member proposed in the present invention.

The first fastening member 104 may have a hollow pipe shape. Similar to the fixing member 102 having the semicircular shape, the first fastening member 104 may be obtained by combining semicircular columns to face each other. That is, the first fastening member 104 may be divided into at least two parts.

As described above, the first fastening member 104 may have a hollow pipe shape, and a diameter of a hollow inside of the first fastening member 104 may not be constant, but may vary. In the present invention, an inner diameter of the first fastening member 104 may be relatively larger at an upper end thereof than a lower end thereof.

An outer side and an inner side of the lower end of the first fastening member 104 may be formed with a screw thread.

An upper inner side of the first fastening member 104 may be formed with a mounting part into which a part of the fixing member 102 having the semicircular shape is inserted. According to FIG. 1, a part of an outer portion of the fixing member 102 may be inserted into the mounting part having a groove shape and formed at an upper portion of the first fastening member 104, and the remaining part thereof may come in close contact with a protruding portion formed at the upper end of the beverage container or a periphery of the protruding portion.

In other words, in a state in which the fixing member 102 is inserted into the mounting part of the first fastening member 104, which is divided into at least two parts, the first fastening member 104 is fastened such that the remaining part of the fixing member 102 may come in close contact with the protruding portion formed at the upper end of the beverage container.

The coupling member 106 may be formed at an inner surface thereof with a screw thread corresponding to the screw thread formed on the outer surface of the first fastening member 104. In addition, the coupling member 106 may include a belt or a coupling that functions to fix components of the first fastening member 104 such that the components combined with each other can be prevented from being separated from each other.

The second fastening member 108 may have a hollow pipe shape, and a screw thread may be formed on an outer surface of the second fastening member 108. An upper end of the second fastening member 108 may be is formed with a seal ring mounting part, and a seal ring 108a may be mounted in the seal mounting part.

The second fastening member 108 may be inserted into the first fastening member 104 having the hollow pipe shape, and the first fastening member 104 and the second fastening member 108 may be fixed to each other by the screw thread. In addition, when the second fastening member 108 is inserted into the first fastening member 104 by using the screw thread, the upper end of the second fastening member 108 may come in close contact with an upper end of a cap 12. In addition, since a part of the seal ring 108a is inserted into the upper end of the second fastening member 108, the upper end of the second fastening member 108 may come into close contact with the upper end of the cap 12 by the seal ring 108a.

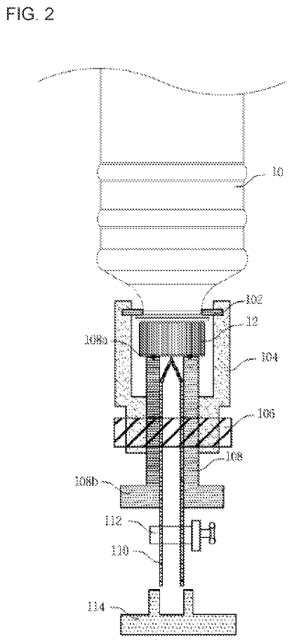

According to FIG. 2, the upper end of the second fastening member 108 is in close contact with the cap 12.

The second fastening member 108 may be provided at a lower end thereof with a knob part 108b having a relatively large diameter for enabling the rotation through the screw thread, and the second fastening member 108 may be inserted into the first fastening member 104 by rotating the knob part 108b.

The perforating member 110 may have a hollow pipe shape, and a longitudinal end of the perforating member 110 may have a conical shape to perforate the cap 12. A plurality of through holes 110a may be formed in the conical end of the perforating member 110, and the through holes 110a may be connected to an internal empty space of the perforating member 110.

The perforating member 110 may be screwed with the second fastening member 108, or may be coupled to the second fastening member 108 through various fastening methods in various shapes.

The length of the perforating member 110 may be relatively longer than the length of the second fastening member 108, so that the perforating member 110 may protrude out of the second fastening member 108 in a state in which the perforating member 110 is inserted into the second fastening member 108.

The longitudinal end of the perforating member 110 may be provided with a pressing member 114 that can be separated from the perforating member 110. The pressing member 114 may be formed at an inner portion of an upper end thereof with an inlet groove 114a such that the other longitudinal end of the perforating member 110 may be inserted into the pressing member 114. When the pressing member 114 is pressed from the bottom to the top in a state in which the perforating member 110 is inserted, the perforating member 110 may also move from the bottom to the top.

A stop valve 112 may be connected to the perforating member 110 and may function to block an empty space formed in the perforating member 110. In other words, the step valve 112 may serve to block the movement of the beverage into the interior space.

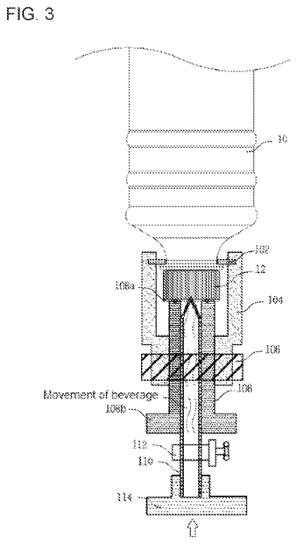

FIG. 3 is a view showing the operation of an automatic opening/closing device for the cap of the beverage container according to one embodiment of the present invention. Hereinafter, the configuration of the automatic opening/closing device for the cap of the beverage container according to one embodiment of the present invention will be described in detail with reference to FIG. 3

Referring to FIG. 3, when the pressing member 114 is pressed, the perforating member 110 that has been inserted may move to the top. When the perforating member 110 moves to the top, the cone formed at the longitudinal end of the perforating member may perforate the cap. When the cap is punctured, the beverage inside the container may be moved into the inside of the perforating member 110 through the through holes 110a formed in the cone and may be discharged to the outside.

The user may block the movement of the beverage moving through the inside of the perforating member 110 by using the stop valve 112, and air can be prevented from being leaked to the outside because the second fastening member 108 comes into close contact with the cap due to the seal ring 108a provided at an upper end of the second fastening member 108 and the fixing member 102 inserted into the mounting part. Thus, the user can drink the beverage by manipulating the stop valve 112, and can block the movement of the beverage moving through the inside of the perforating member 110 by rotating the stop valve 112, as needed.

Although the present invention has been described with reference to one embodiment shown in the drawings, this is merely illustrative, and those skilled in the art will understand that various modifications and other equivalent embodiments are possible.

1. A device for preventing leakage of gas within a container, the device comprising:
a fixing member including at least two parts combined with each other and corresponding to an upper portion of a beverage container;
a first fastening member including at least two parts combined with each other to form a hollow pipe shape, provided at an upper inner portion thereof with a mounting part configured to install the fixing member, and provided at outer and inner portions of a lower end thereof with a fastening part;
a coupling member configured to fix the first fastening member in a combined state;
a second fastening member having a hollow pipe shape, provided at an upper end thereof with a seal ring mounting part into which a seal ring is partially inserted, and inserted into the first fastening member by a screw thread formed at an outer side thereof;
a perforating member inserted into the second fastening member, having a hollow pipe shape, formed at a conical upper end thereof with a through hole, and having a lower end which is opened; and
a pressing member into which a lower end of the perforating member is inserted.

2. The device of claim 1, wherein a length of the perforating member is relatively longer than a length of the second fastening member, and the device includes a stop valve coupled to the perforating member to block a movement of a beverage moving to a bottom through the through hole

3. The device of claim 2, wherein the fixing member includes two semicircular parts, in which a part of an outer portion of the fixing member is fixed to the mounting part provided at the upper portion of the first fastening member, a part of an inner portion of the fixing member comes in close contact with a lower end of a cap of the container, and a remaining part of the seal ring comes in close contact with an upper end of the cap.
